(19) United States
(12) Patent Application Publication
(10) Pub. No.: US 2023/0296509 A1
(43) Pub. Date: Sep. 21, 2023

(54) REFRACTOMETER, OPTICALLY TRANSMISSIVE STRUCTURE, AND METHOD OF MAKING AN OPTICALLY TRANSMISSIVE STRUCTURE

(71) Applicant: ALEX ANTON FEMEC, Kent, OH (US)

(72) Inventor: ALEX ANTON FEMEC, Kent, OH (US)

(21) Appl. No.: 17/695,536

(22) Filed: Mar. 15, 2022

(51) Int. Cl. G01N 21/41; G01N 21/43

(52) U.S. Cl. CPC G01N 21/4133; G01N 21/43; G01N 2021/414

(57) ABSTRACT

Provide herein is a refractometer, optically transmissive structure, and method of making. The structure has a first surface disposing a light source. A second surface is configured and disposed to provide an angular light reflective interface at, or proximate therewith, a fluid being sensed. A third surface disposes an optical sensor. The optically transmissive structure has at least one of the light source and the optical sensor directly incorporated, bonded, or adhered therewith or has at least one light blocker configured and disposed to block a portion of light being directed or reflected toward the third surface.

### FIELD OF THE DISCLOSURE

This disclosure relates generally to refractometers and optically transmissive structures configured to measure concentrations of solutes in solvents, such as organics or oil in solvents such as water.

### BACKGROUND

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

The present disclosure relates to a refractometer and optically transmissive structure used in the measurement of concentration of solutes, such as soluble lubricants or oil in solvents, such as water. For example, soluble lubricants such as soluble oil in water may be used to increase the effectiveness of metal cutting by providing cooling and lubrication of the cutting tool.

Refractometers are widely used to measure concentration of a fluid mixture by passing light through an optically transmissive structure (e.g., prism), while allowing it to reflect internally off the interface of the optically transmissive structure and the mixture or solution being tested. The reflections occur over an angular range determined by the geometry of the optically transmissive structure and light source. The range includes a critical angle such that rays meeting the interface at an angle greater than the critical angle reflect internally and rays meeting the interface at an angle less than the critical angle pass through the interface into the fluid or solution being tested. This forms a spatial transition from the presence of reflected light to the absence of reflected light across the planar surface of the photoelectric sensor. The geometry of this transition changes as the refractive index of the fluid changes. By examining the signal from the photoelectric sensor the refractive index of the fluid mixture may be determined, which may be proportional to the concentration of one or more solutes, such as a lubricant, in the liquid mixture or fluid being sensed or monitored.

Problems encountered with refractometers may include a relative movement of the components which may result in a loss of repeatability and accuracy in the measurement over a period of time. Additionally, a lens may be required to be placed in internal cavities between optical components. These internal cavities may be susceptible to ingress of fluid which may obstruct light rays and degrade the effectiveness of the measurement. The optically transmissive structure and housing are generally made from differing materials, and as a result have differing degrees of expansion and contraction over varying temperatures. This may provide a means for the sample to enter into the refractometer. In order to prevent the ingress of fluid, elastic seals may be needed between the dissimilar materials. The need for elastic seals may lead to greater complexity and greater possibility of malfunction. Additionally, the refractometers of the prior art may require complex manufacturing and assembly methods and machines. It may be desired to have a refractometer that overcomes some of the problems associated with the refractometers of the prior art.

### SUMMARY

In one aspect of the present disclosure, a refractometer having an optically transmissive structure is provided. The optically transmissive structure has a first surface configured and disposed to transmit light emitted from a light source and into the optically transmissive structure. A second surface is configured and disposed to provide an angular light reflective interface at, or proximate, the second surface and a fluid being sensed. A third surface is configured and disposed to transmit the light reflected from the angular light reflective interface and to an optical sensor. The light source is configured and disposed to transmit light through the first surface and into the light transmissive structure. The optical sensor is configured and disposed to sense a portion of the light being reflected toward the third surface. The optically transmissive structure has at least one light blocker configured and disposed to block a portion of the light being directed or reflected toward the third surface.

In another aspect of the present disclosure, a method of making a refractometer is provided. The method comprises stereolithographing, molding, or otherwise forming an optically transmissive structure having a first surface, a second surface, and a third surface. The first surface is configured and disposed to transmit light emitted from a light source and into the optically transmissive structure. The second surface is configured and disposed to provide an angular light reflective interface at, or proximate, the second surface and a fluid being sensed. The third surface is configured and disposed to transmit light reflected from the angular light reflective interface and to an optical sensor. The light source is directly incorporated, bonded, or adhered with an adhesive, within or on the first surface, or, the optical sensor is directly incorporated, bonded, or adhered with an adhesive, within or on the third surface of the optically transmissive structure; The incorporating, bonding, or adhering of the light source or the optical sensor minimizes a scattering of light from the light source and to the optical sensor.

In a further aspect of the present disclosure, a method of making a refractometer is provided. The method comprises utilizing stereolithography or stereolithographing, molding, or otherwise forming a polymeric optically transmissive structure having a first surface, a second surface, and a third surface. The first surface is configured and disposed to transmit light emitted from a light source and into the optically transmissive structure. The second surface is configured and disposed to provide an angular light reflective interface at, or proximate, the second surface and a fluid being sensed. The third surface is configured and disposed to transmit light reflected from the angular light reflective interface and to an optical sensor. The three dimensionally forming comprises three dimensionally forming at least one void, opening, or slot in the optically transmissive structure. The at least one void, opening, or slot is filled with a light blocking material. The at least one filled void, opening, or slot is configured and disposed to block a portion of the light being reflected or transmitted toward the optical sensor.

### BRIEF DESCRIPTIONS OF THE DRAWINGS

The following figures, which are idealized, are not to scale and are intended to be merely illustrative of aspects of the present disclosure and non-limiting. In the drawings, like elements are depicted by like reference numerals. The drawings are briefly described as follows.

FIG. 1 is an illustrative cross-sectional view of an embodiment of the presently disclosed refractometer;

FIG. 2 is an illustrative cross-sectional view of another embodiment of the presently disclosed refractometer;

FIG. 3 is an illustrative cross-sectional view of an additional embodiment of the presently disclosed refractometer;

FIG. 4 is an illustrative cross-sectional view of a further embodiment of the presently disclosed refractometer;

FIG. 5 is an illustrative cross-sectional view of an optically transmissive structure of the present disclosure;

FIG. 6 is an illustrative logic block diagram of an embodiment of a refractometer system of the present disclosure showing a user interface; and

FIG. 7 is an illustrative diagram of a refractometer system of the present disclosure.

### DETAILED DESCRIPTION

Presently disclosed is a refractometer, a method of making a refractometer, an optically transmissive structure, and a system for measuring a concentration of a solute in a solvent. Aspects of the present may provide simplicity of manufacturing and assembly over the prior art. The presently disclosed refractometer or optically transmissive structure may be constructed without requiring glass lenses, optical filters, or glass optically transmissive structures (e.g., prisms) which typically need to be ground and polished. The disclosed polymeric optically transmissive structure, or a combination of a planar glass window with the polymeric structure, may allow the desired properties of a fluid interface of an optically transmissive structure that is simpler to manufacture and may allow for more geometric complexity.

For example, the presently disclosed refractometer and system may provide for the measurement of a concentration of a solute in a solvent such as the concentration of a lubricant in water. Aspects of the presently disclosed refractometer may provide for greater reliability of measurement over a period of time, less complexity in production of the refractometer, or both, than present refractometers. The presently disclosed refractometer may have a unitary or a composite optically transmissive structure.

Aspects of the present disclosure may provide for a refractometer that may be submerged in a cooling lubricating mixture or fluid or may be placed into a path of its flow. For example, the refractometer of the present disclosure may be placed within a piped system in order to provide continuous monitoring of solute(s) in a solvent. Aspects of the presently disclosed refractometer may offer simplicity of manufacturing and assembly over the prior art. The presently disclosed refractometer may be constructed without requiring glass lenses, optical filters, or glass optically transmissive structures (e.g., prisms) which may need to be ground and polished. Aspects of the presently disclosed refractometer may have a combination of a planar glass window and a polymer optically transmissive structure. This combination may allow for the desired properties of glass at the fluid interface and that of an optically transmissive structure while providing for a less complex manufacturing process and allowing for more geometric complexity than which may be obtained with glass.

In prior art arrangements, the optically transmissive structure typically must be made from a transparent material which has a high index of refraction relative to the fluid to be measured, and high durability when exposed to the fluid to be measured. Typically, the optically transmissive structure is made from glass or the like, and has surfaces which must be ground to particular relative angles and polished to a high degree of smoothness to provide a reliable measurement. The prior optically transmissive structure fabrication may require a specialized process and which may incur significant expense.

The presently disclosed refractometer may allow for a less complex fabrication or method of making, which in turn may provide for a lower cost method of manufacturing. For example, component parts of the presently disclosed refractometer in the optical assembly may be bonded to the optically transmissive structure with transparent adhesive or be incorporated directly into or onto the optically transmissive structure. These compositions or methods of construction may result in a highly stable structure, which in turn may provide for an improved long term measurement performance. An interface between a planar window and a housing may provide for a simplified method of construction or assembly as it may eliminate the need for an elastic seal between an angular optically transmissive structure and a housing. For example, an absence of cavities in the path of the light rays may eliminate, or substantially mitigate, optical problems due to fluid ingress and condensation on optical surfaces.

Due to the ease of which complex shapes may be formed from polymer materials, by stereolithography or molding for example, partitions may be readily placed in the optically transmissive structure. These partitions may be filled with a light blocking material to minimize the transmission of undesirable light rays to a sensor. The minimization of undesired light rays may mitigate the degradation of the measurement capability of the presently disclosed refractometer.

Reference will now be made in detail to the present exemplary embodiments and aspects of the present invention, examples of which are illustrated in the accompanying figures. Wherever possible, similar reference numbers will be used throughout the figures to refer to the same or like parts.

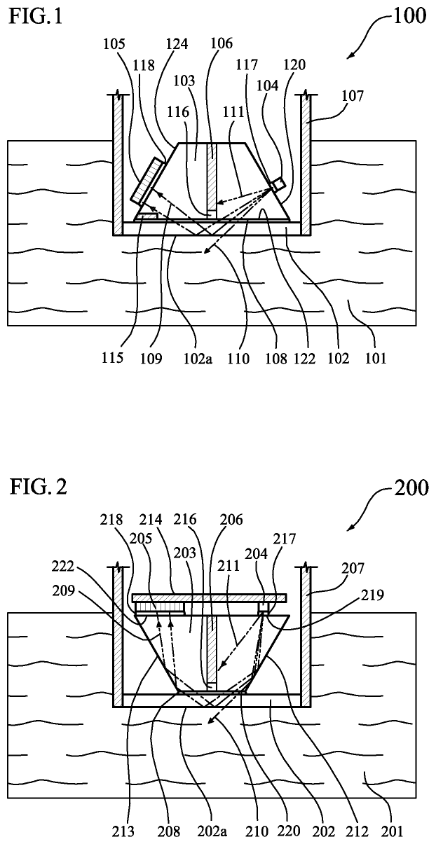

FIG. 1 is an illustrative cross-sectional view of refractometer 100. Refractometer 100 may have a housing 107 and a window 102 mounted therewith. Refractometer 100 is shown submerged in fluid 101 to be measured. An optically transmissive structure 103 may be bonded to window 102 with a transparent adhesive 108. Light source 104 is configured and disposed to emit light rays 109, 110, and 111, some of which pass through optically transmissive structure 103 and window 102 and reflect off the interface 102a, between window 102 and fluid 101, for example, light rays 109. Light source 104 may have at least one light-emitting-diode, LED. For example, light source 104 may be a sole LED or an array of LEDs. Other and different light sources as are known by persons having ordinary skill in the art may be configured and disposed to emit light toward interface 102a.

Some light rays 110 may pass into fluid 101 instead of reflecting. A portion of the reflecting light rays 109 reach the optical sensor 105. Light rays emitted by light source 104, intersect interface 102a at various angles over a range that contains a critical angle. Rays above the critical angle pass through interface 102a and into fluid 101, rays 110. Rays below the critical angle reflect at the interface 102a and may continue to optical sensor 105, rays 109. Depending on the refractive index of fluid 101, a portion of the incoming light below the critical angle of total reflection is transmitted to optical sensor 105, whereas for higher angles of incidence, the light transmitted into the sample or fluid 101. This dependence of the reflected light intensity from the incident angle is measured with optical sensor 105. The detection of the critical angle of the sample provides a means for detecting a concentration of a solute in the solvent, or the concentration of a constituent in fluid 101.

Transparent adhesive 117 may be used to bond light source 104 to optically transmissive structure 103. Transparent adhesive 118 may be used to bond optical sensor 105 to optically transmissive structure 103. The adhesives may have a low enough viscosity relative to the roughness of the bonded surface and optical properties, such that the interface may be substantially transparent and be substantially unaltering to light rays 109, after assembly. This may provide for assembly of refractometer 100 without a need for polishing of surfaces of optically transmissive structure 103. For example, adhesive materials may include, but not limited, to acrylic, silicone, epoxy, and urethane.

Optical sensor 105 may be monitored and the location of the transition from reflected light to non-reflected light may be obtained by scanning of the optical sensor 105 pixels. A portion of the light rays 111, emitted by light source 104, may be stopped by the partition 106, which may prevent the light rays from reaching the optical sensor 105, which may degrade the measurement quality. Partitions 115 and/or 106 may be positioned to block stray light from reaching optical sensor 105 and degrading the measurement quality.

Optically transmissive structure 103 may be housed in housing 107. Housing 107 may be submerged in an open tank of fluid 101 or placed in the stream of flow within a piped system carrying fluid 101. It is known by persons having ordinary skill in that art that a higher sensing accuracy may be achieved by utilizing temperature compensation of the measured value due to the natural shift in the critical angle with temperature changes of the fluid 101 and/or window 102. A temperature sensor 116 may be included to allow for this correction. In at least one embodiment of the present disclosure, temperature sensor 116 may be located adjacent or proximate window 102 to provide a short response time in detecting temperature changes in fluid 101.

In at least one embodiment of the present disclosure, refractometer 100 has optically transmissive structure 103. Optically transmissive structure 103 a first planar surface 120 configured and disposed to transmit light emitted from a light source, light source 104 for example, and into optically transmissive structure 103. A second planar surface 122 is configured and disposed to provide an angular light refractive or reflective interface at second planar surface 122, or proximate therewith (for example at window 102) and a fluid being sensed, for example fluid 101. A third planar surface 124 is configured and disposed to transmit light reflected from the angular light refractive interface and to optical sensor 105. Refractometer 100 has at least one light blocker, for example at least one of light blockers 106 and 115, configured and disposed to block a portion of the light being transmitted into or through light transmissive structure 103. Light source 104 is configured and disposed to transmit light through first planar surface 120 and into the light transmissive structure 103. Optical sensor 105 is configured and disposed to sense a portion of the light being transmitted to third planar surface 124.

In at least one embodiment, A refractometer 100 has an optically transmissive structure 103 having a first surface 120 configured and disposed to transmit light emitted from light source 104 and into optically transmissive structure 103, a second surface 122 configured and disposed to provide an angular light reflective interface at, or proximate, second surface 122 and a fluid being sensed 101, and a third surface 124 configured and disposed to transmit a portion of the light reflected from angular light reflective interface 102a and to optical sensor 105. Light source 104 is configured and disposed to transmit light through first surface 120 and into light transmissive structure 103. Optical sensor 105 is configured and disposed to sense a portion of the light being reflected toward third surface 124. At least one light blocker, 106 and 115, is configured and disposed to block a portion of the light being directed or reflected toward the third surface 124.

In at least one other embodiment, optically transmissive structure 103 is polymeric. At least one light blocker, 106 and/or 115, may comprise a void, slot, or opening in the polymeric optically transmissive structure filled with a light blocking material. At least one light blocker, 106 may be configured and disposed to block a portion of the light being transmitted through optically transmissive structure 103 and toward angular light reflective interface 102a.

In at least one embodiment, second surface 122 of optically transmissive structure 103 is planar. For example, window 102 may adhered or bonded to, or incorporated with, planar second surface 122. Window 102 may be configured and disposed to provide angular light reflective interface 102a proximate second surface 122 and the fluid being sensed 101. Housing 107 may be disposed about optically transmissive structure 103. Light source 104 may have at least one LED.

FIG. 2 is an illustrative cross-sectional view of refractometer 200. By arranging the optically transmissive structure 203 as shown in FIG. 2, the optical sensor 205 and light source 204 may be located in a similar or same plane which may enable them to both be mounted to a common printed circuit board 214. Light rays emitted by light source 204 may transmitted internally, within optically transmissive structure 203, and internally reflected off of surface 212, reflected off interface 202a, and reflect off surface 213, before reaching optical sensor 205, as shown with light rays 209. Surfaces 212 and 213 and interface 202a may be planar.

Refractometer 200 may have a housing 207 and a window 202 mounted therewith. Refractometer 200 is shown submerged in fluid 201 to be measured. Optically transmissive structure 203 may be bonded to window 202 with a transparent adhesive 208. Light source 204 is configured and disposed to emit light rays 210, 211, and 209. Some light rays 210 may pass into fluid 201 and some light rays 211 may be blocked by light blocker 206. For example, light blocker 206 may be configured and disposed to block a portion of the light being transmitted into or through the light transmissive structure 203.

In at least one embodiment, optically transmissive structure 203 has a first surface 219 configured and disposed to transmit light emitted from light source 204 and into the optically transmissive structure 203. Second surface 220 is configured and disposed to provide an angular light reflective interface at, or proximate, second surface and a fluid being sensed, for example surface 202a, Third surface 222 is configured and disposed to transmit a portion of the light reflected from the angular light reflective interface and to optical sensor 205. One or more of the surfaces may be in substantially the same plane, For example, first surface 219 may be in substantially the same plane as third surface 222. Optically transmissive structure may have additional surfaces for the internal reflection of light. For example, surface 212 may be configured and disposed to reflect light from light source 204 to the angular light reflective interface and/or surface 213 may be configured and disposed to reflect light from light to sensor 205.

Temperature sensor 216 may be disposed adjacent or proximate window 202 to provide for the detecting of the temperature, or a change in temperature, of fluid 201. Adhesive material(s) 217 and/or 218 may be configured and disposed to hold light source 204 and/or sensor 205 to optically transmissive structure 203. Adhesives 217, 218, and 208 may provide for the transmission of light therethrough with minimal, negligible, or no scattering, reflecting, or refracting of light and may eliminate a need to smooth or polish the surfaces to which they are adhered.

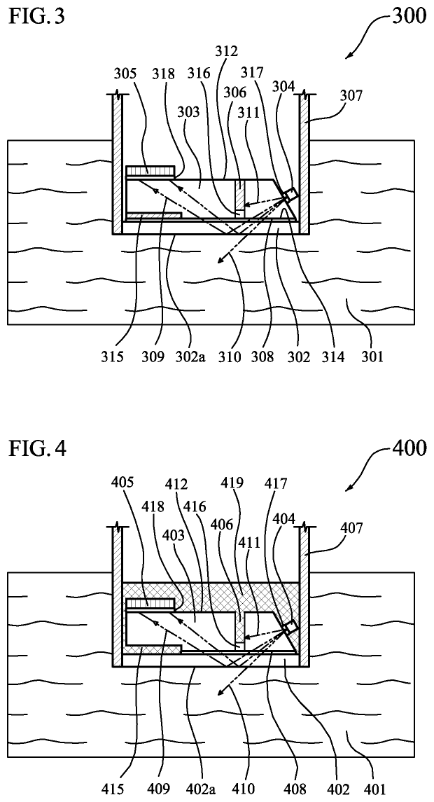

FIG. 3 shows an illustrative cross-sectional view of refractometer 300. By arranging the optical sensor 305 to be mounted to the upper surface 312 of optically transmissive structure 303, optical sensor 305 may be disposed parallel to the window 302. This configuration may allow optically transmissive structure 303 to fit into a smaller space, and may not require, or minimize, internal reflections off of surfaces of optically transmissive structure 303. This may obviate a need to smooth or polish planar surfaces of optically transmissive structure 303. For example, surface 314 may be a sole planar surface for internally reflecting which may be desired to be smoothed to provide an angular light reflective interface. In at least one embodiment, window 302 is adhered to optically transmissive structure with adhesive 308. Adhesive 308 may have leveling or smoothing properties and may provide an interface between window 302 and optically transmissive structure 303 that minimizes or eliminates a change in path of light rays 309 as they pass through the interface between optically transmissive structure 303 and window 302, as indicated with light rays 309 reflecting off of angular light reflective interface 302a.

A partition, or light blocker, may fully bisect optically transmissive structure 303, but other arrangements are within the scope of the present disclosure as embodiments having partition 306 only partially bisecting optically transmissive structure 303 may allow for optically transmissive structure 303 to be manufactured as one piece of material. For example, optically transmissive structure 303 may be formed with a slot or planar opening and filled with a light blocking material, thus forming light blocker 306 within a unitary optically transmissive structure 303. This arrangement or method of construction may provide for a desired degree of light blocking with light blocker 306, as illustrated with light rays 311. Partition, or light blocker 315, may be horizontally disposed adjacent window 302. A portion of the light rays, 310, may pass through interface 302a and into fluid 301.

Window 302 may be made from glass or other optically dense material and may be selected to have a desired index of refraction suitable for the desired measurement range for fluid 301. A planar or flat window 302 may be desirable as optical glasses may readily available in sheet form which may not require special grinding or smoothing. In addition, a flat window 302 may be readily mounted flush with edges of outside housing 307, which may allow the refractometer to be easily inserted into a fluid 301 without trapping bubbles of air against window 302, which may degrade the measurement quality.

Window 302 may comprise a variety of glass types such as borosilicate glass, sapphire, N-BK7, N-K5, N-F2, N-LFS, N-SFS, N-SK10, and the like. Optically transmissive structure 303 may be fabricated from various materials that are transparent to light emitted from the light source, light source 304, including but not limited to acrylic, polycarbonate, or epoxy. Possible fabrication methods for optically transmissive structure 303 may include, but not limited to, machining from a solid piece of material, or forming from liquid, flowable, or molten resin by casting or molding. Additionally, optically transmissive structure 303 may be from a curable resin, such as a photosensitive resin, or with stereolithography. Light source 304 may be adhered to optically transmissive structure 303 with adhesive 317. Light sensor 305 may be formed on or in surface 312 or adhered thereto with adhesive 318.

The thickness of window 302 may be selected to allow sufficient structural integrity during thermal stresses that may be encountered due to differing thermal expansion of the window 302 and optically transmissive structure 303. For example, a 2 mm thick borosilicate glass may provide adequate structural integrity for measuring fluids with an index of refraction in the range of 1.33 to 1.40. Adhesive layer 308 may have an optically clear acrylic adhesive, or other adhesive, with sufficient thickness and elasticity to allow differing relative thermal expansion of the window 302 and optically transmissive structure 303. Measurement effects from the thermal distortions may be removed from the output during a temperature compensation step. Temperature sensor 316 may be disposed adjacent or proximate window 302, for example, temperature sensor 316 may be positioned in a lower end of light blocker 306.

Optical sensor 305 may be adhered to optically transmissive structure 303 with adhesive 318 and may be configured to convert luminous intensity at one or more locations into an electrical signal. For example, optical sensor 305 may contain an integrated circuit that may include one or more photo-diodes, a charge-coupled device (CCD), or a complementary metal oxide semiconductor (CMOS).

FIG. 4 is an illustrative cross-sectional view of disclosed refractometer 400. By forming optically transmissive structure 403 with a void in the locations of the desired partition 406 and partition 415, the placement of a non-transmissive encapsulation material, or light blocking material, 419 into a cavity in housing 407, surrounding optically transmissive structure 403, creates partitions with a desired light blocking orientation and properties. For example, the use of stereolithography for making optically transmissive structure 403 may allow for complex geometries. Partition or light blocker 406 may be configured and disposed to block light 411. The non-transmissive encapsulation material 419 may be formed from a polymer resin by pouring the resin into the cavity within housing 407 before curing of the resin. Possible materials used to form the encapsulation material 419 may include, but not limited to, epoxy resin, acrylic resin, and liquid silicone.

By arranging the optical sensor 405 to be mounted to the upper surface 412 of optically transmissive structure 403, optical sensor 405 may be disposed parallel to the window 402. In at least one embodiment, window 402 is adhered to optically transmissive structure 403 with adhesive 408. Light rays emitted by light source 404 may transmitted internally, within optically transmissive structure 403, and reflect off surface 402a to reach optical sensor 405, as shown with light rays 409. A portion of the light rays, 410, may pass through interface 402a and into fluid 401.

Adhesive material(s) 417 and/or 418 may be configured and disposed to hold light source 404 and/or sensor 405 to optically transmissive structure 403. Adhesives 417, 418, and 408 may provide for the transmission of light therethrough with minimal, negligible, or no scattering, reflecting, or refracting of light and may eliminate a need to smooth or polish the surfaces to which they are adhered. Temperature sensor 416 may be disposed adjacent or proximate window 402, for example, temperature sensor 416 may be positioned in a lower end of light blocker 406.

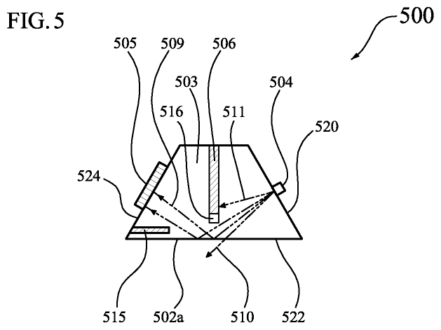

FIG. 5 is an illustrative cross-sectional view of optical sensing device 500. Light source 504 is configured and disposed to emit light rays 510, 511, and 509, some of which pass through optically transmissive structure 503 and reflect off the interface 502a, between optically transmissive structure 503 and a material being sampled, for example, light rays 509. Some light rays 510 may pass through interface 502a and into the material being sampled, instead of reflecting. A portion of the reflecting light rays 509 reach the optical sensor 505 for sampling at least one constituent in the material being sampled. One or more light blockers, 506 and 515, may be disposed in optically transmissive structure 503. For example, light blockers 506 and 515 may be positioned to block light that is not indicative of the critical angle being sensed with sensor 505, for example light 511. Temperature sensor 516 may be disposed adjacent or proximate interface 502a, for example, temperature sensor 516 may be positioned in a lower end of light blocker 506.

Optically transmissive structure 503 may be stereolithographed, molded, or otherwise formed to have a desired shape or configuration. Stereolithography, such as 3-D printing, may comprise heating a polymeric material to a molten state and depositing the material, or printing the material, into a desired shape or configuration. Optically transmissive structure 503 may be stereolithographed or otherwise formed, such as molded, directly onto a window, if desired, which may avoid a need for an adhesive. Alternatively, optically transmissive structure 503 may be comprised of a material that is resistant to a fluid or material being sensed and may have optical properties that may obviate a need for a window or housing. For example, lower surface 522 may be configured and disposed to provide for an angular light reflective interface 502a without a window.

In at least one embodiment, at least one of light source 504 and sensor 505 are disposed in, or directly on, the optically transmissive structure 503. For example, light source 504 and sensor 505 may be stereolithographed, or otherwise formed, directly onto, or in, optically transmissive structure 503 which may eliminate any requirement for adhesives. Alternatively, a polymeric optically transmissive structure 503 may be may be formed from a flowable polymeric material. For example, optically transmissive structure 503 may comprise a polymeric material and the incorporating, bonding, or adhering may placing the light source, the window, or the optical sensor onto or into a flowable polymeric material and solidifying the flowable polymeric material. In at least one embodiment, optically transmissive structure 503 is formed by a flowable polymeric material, such as one or more curable resins or by heating to a molten state. While in a flowable form, sensor 505 or light source 504 may be bonded to the surface of optically transmissive structure 503. Light blocker 506 and/or 515 may be formed by stereolithographing or otherwise forming a trough, slot, or other void space in optically transmissive structure 503 and filling it with a light blocking material.

A method of making an optically transmissive structure 503 may comprise utilizing stereolithography or stereolithographing, molding, or otherwise forming optically transmissive structure 503 having a first surface 520, a second surface 522, and a third surface 524. First surface 520 is configured and disposed to transmit light emitted from light source 504 and into optically transmissive structure 503. Second surface 522 is configured and disposed to provide an angular light reflective interface 502a at, or proximate therewith, a fluid being sensed. Third surface 524 is configured and disposed to transmit light reflected from angular light reflective interface 502a and to optical sensor 505. One or both of light source 504 and light sensor 505 may be directly incorporated or bonded with optically transmissive structure 503. For example, at least one of light source 504 and light sensor 505 may be formed into, or on, optically transmissive structure 503 while its material of structure is in a molten or semi-molten state. In at least one embodiment, the incorporating, bonding, or adhering of light source 504 or optical sensor 505 minimizes a scattering of light from light source 504 and to optical sensor 505.

In at least one embodiment, a window is directly incorporated, bonded, or adhered to second surface 522. The window is configured and disposed to provide an angular light reflective interface proximate second surface 522 and the fluid being sensed. In at least one other embodiment, a step of incorporating, bonding, or adhering may comprise adhering at least one of light source 504, the window, and/or optical sensor 505 to optically transmissive structure 503 with an adhesive.

The adhesive may be configured and disposed to reduce light scattering by an amount sufficient to provide at least a 90% desired light transmission, wherein the desired light transmission is shown with light rays 509. In at least one embodiment, the optical sensor is directly incorporated, bonded, or adhered with an adhesive, within or on the optically transmissive structure. In at least one other embodiment, angular light reflective interface 502a is smoothed or has a surface, such as a window, directly incorporated, bonded, or adhered with an adhesive. For example, angular light reflective interface 502a may be smoothed by adhering an adhesive therewith or by polishing. In at least one further embodiment, optically transmissive structure 503 has at least one light blocker. The combination of the light blocker and the incorporation, bonding, or adhering of the sensor provide may be sufficient to provide at least a 90% desired light transmission.

Alternatively, the incorporating, bonding, or adhering comprises incorporating or bonding at least one of light source 504, the window, and optical sensor 505 to optically transmissive structure 503. For example, optically transmissive structure 503 may comprise a polymeric material and the incorporating or bonding may comprise heating a portion of the polymeric material to a molten or semi-molten state and placing light source 504, the window, or optical sensor 505 onto or into the molten or semi-molten polymeric material. In at least one embodiment, the incorporating or bonding may comprise stereolithographing the polymeric material at least one of source 504, the window, or optical sensor 505 onto or into the molten or semi-molten polymeric material.

In at least one embodiment, a method of making optically transmissive structure 503 comprises utilizing stereolithography or stereolithographing, molding, or otherwise forming a polymeric optically transmissive structure having a first surface 520, a second surface 522, and a third surface 524. First surface 520 is configured and disposed to transmit light emitted from light source 504 and into optically transmissive structure 503. Second surface 522 is configured and disposed to provide an angular light reflective interface 502a at, or proximate, second surface 522 and a fluid being sensed. Third surface 524 is configured and disposed to transmit light reflected from angular light reflective interface 502a and to optical sensor 505. The three dimensionally forming may comprise three dimensionally forming at least one void, opening, or slot in optically transmissive structure 503. The at least one void, opening, or slot is filled with a light blocking material. The at least one filled void, opening, or slot, 506 and/or 515, is configured and disposed to block a portion of the light being reflected or transmitted toward the optical sensor 505. For example, the filled void, opening, or slot may be configured and disposed to block a portion of light below a critical angle, light ray 511 for example. Alternatively or additionally, the filled void, opening, or slot may be configured and disposed to block a portion of light above a critical angle at angular light reflective interface 502a. A void, opening, or slot may be configured and disposed to block a portion of light between light source 504 and angular light reflective interface 502a, for example light blocker or filled void, opening, or slot 506. Alternatively or additionally, a void, opening, or slot may be configured and disposed to block a portion of light between angular light reflective interface 502a and optical sensor 505, for example light blocker or filled void, opening, or slot 515. In at least one embodiment, a method of making optically transmissive structure 503 comprises forming a first and a second void, opening, or slot therein. The first void opening, or slot is configured and disposed to block a portion of light between the light source and the angular light reflective interface and the second void, opening, or slot is configured and disposed to block a portion of light between the angular light reflective interface and the optical sensor.

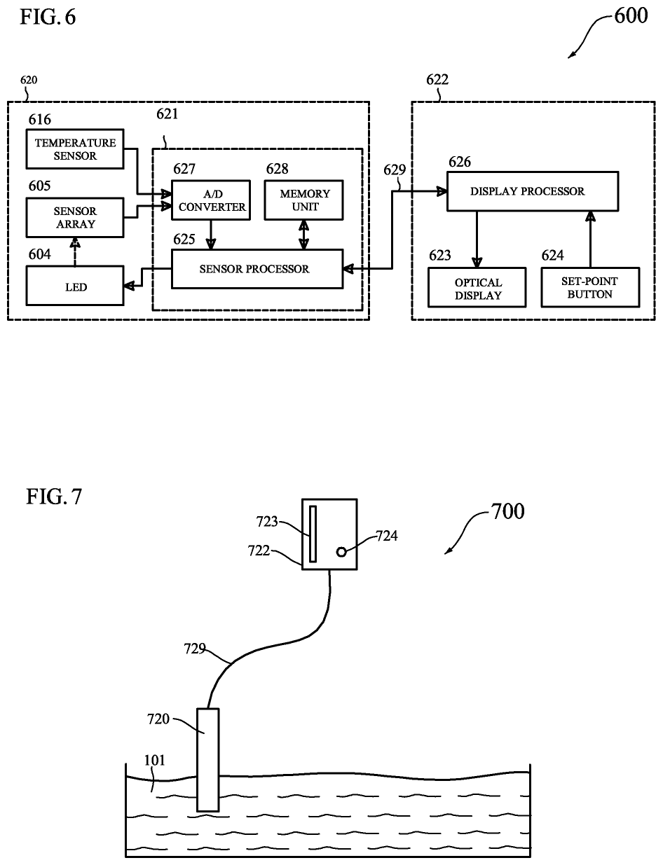

FIG. 6 is an illustrative logic block diagram of refractometer system 600 with a user interface. A submersible assembly 620 may have light source 604, an optical sensor 605, and a microcontroller 621. Microcontroller 621 may have a sensor processor 625, A/D converter 627 and non-volatile memory unit 628. Sensor processor 625 initiates a measurement by turning on light source 604. The light rays emitted with light source 604 illuminate optical sensor 605. Sensor processor 625 then scans the optical sensor 605 through A/D converter 627, resulting in a digital reading which is proportional to a concentration of a solute being measured in a solvent.

Display module 622 contains a microcontroller with a display processor 626, an optical display 623, and a set-point button 624. The optical display 623 may be made up of an array of light sources which may be arranged in a bar-graph formation, such that when the measurement matches the stored set-point a center light source is illuminated. Measurements that represent lower or higher concentrations of the solute may cause the center light source to become non-illuminated, and also may cause a light source that is in a position which is proportional to the relative measurement to become illuminated. The measurements and display updates proceed in a repeated and continuous fashion. The user may actuate the set-point button 624, signaling the display processor 625 to transmit the current reading to the non-volatile memory unit 628 for storage and use in future comparisons. A cable 629 may provide a path for communication signals between the sensor processor 625 and the display processor 626.

FIG. 7 is an illustrative diagram of refractometer system 700. In at least one embodiment, a physical arrangement of the presently disclosed refractometer and user interface is illustratively shown in FIG. 7. Submersible assembly 720 is located in fluid 101 allowing measurements to be performed. A cable 729 provides a path for communication signals between the submersible assembly 720 and display units. Display module 722 contains an optical display 723 and a set-point button 724. The cable is sufficient length to allow the submersible assembly 720 to be in a location that isn't readily accessible by the user, and the display module 722 to be in a location that allows the user to easily see the display.

It will be understood that the examples of patents, published patent applications, and other documents which are included below in this application and which are referred to in paragraphs which state “Some examples of . . . which may possibly be used in at least one possible embodiment of the present application . . . ” may possibly not be used or useable in any one or more embodiments of the application. These references, or portions thereof, are hereby incorporated by reference herein. The purpose of incorporating U.S. patents, foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

Some examples of features which may possibly be utilizable by at least one possible embodiment may possibly be found in the following which are incorporated by reference herein: US20020159050, titled “HAND-HELD AUTOMATIC REFRACTOMETER”, by Sharma, Keshav D. et al., filed 2001 Apr. 26; US20110168876, titled “OPTICAL MODULE AND SYSTEM FOR LIQUID SAMPLE”, by Hsiao, Hsiung et al., filed 2010 Jan. 14; US20160377538, titled “ARRANGEMENT IN CONNECTION WITH MEASURING WINDOW OF REFRACTOMETER, AND REFRACTOMETER”, by Kamrat, Esko, filed 2016 Jun. 27; US20200393372, titled “OPTICAL REFRACTOMETER AND REAL TIME MONITORING ANALYSIS DEVICE HAVING THE SAME”, by Lee, Sang-shin et al., filed 2019 Feb. 20; US20210048388, titled “PORTABLE REFRACTOMETER”, by Shechterman, Mark, filed 2019 Mar. 10; 6067151, titled “REFRACTOMETER”, by Salo, Harri, filed 1998 Dec. 7; 6097479, titled “CRITICAL ANGLE SENSOR”, by Melendez, Jose L. et al., filed 1997 Oct. 1; 6760098, titled “REFRACTOMETER”, by Salo, Harri, filed 2001 Aug. 1; 6816248, titled “HAND-HELD AUTOMATIC REFRACTOMETER”, by Sharma, Keshav D. et al., filed 2001 Apr. 26; and 7492447, titled “REFRACTOMETER”, by Nakajima, Yoshinori et al., filed 2003 Oct. 28; 7916285, titled “REFRACTOMETER”, by Amamiya, Hideyuki et al., filed 2008 Aug. 13; 9632024, titled “OPTICAL SENSOR APPARATUS TO DETECT LIGHT BASED ON THE REFRACTIVE INDEX OF A SAMPLE”, by Chiarello, Ronald et al., filed 2014 Nov. 3.

1. A refractometer comprising:
an optically transmissive structure comprising:
a first surface configured and disposed to transmit light emitted from a light source and into the optically transmissive structure;
a second surface configured and disposed to provide an angular light reflective interface at, or proximate, the second surface and a fluid being sensed; and
a third surface configured and disposed to transmit a portion of the light reflected from the angular light reflective interface and to an optical sensor;
wherein the light source is configured and disposed to transmit light through the first surface and into the light transmissive structure; and
wherein the optical sensor is configured and disposed to sense a portion of the light being reflected toward the third surface; and
the refractometer further comprising at least one light blocker configured and disposed to block a portion of the light being directed or reflected toward the third surface.

2. The refractometer of claim 1, wherein the optically transmissive structure is polymeric.

3. The refractometer of claim 2, wherein the at least one light blocker comprises a void, slot, or opening in the polymeric optically transmissive structure filled with a light blocking material.

4. The refractometer of claim 2, wherein the at least one light blocker is configured and disposed to block a portion of the light being transmitted through the optically transmissive structure and toward the angular light reflective interface.

5. The refractometer of claim 1, wherein the second surface of the optically transmissive structure is planar.

6. The refractometer of claim 4, further comprising a window adhered or bonded to, or incorporated with, the planar second surface, the window is configured and disposed to provide the angular light reflective interface proximate the second surface and the fluid being sensed.

7. The refractometer of claim 1, further comprising a housing disposed about the optically transmissive structure.

8. The refractometer of claim 1, wherein the light source comprises a LED.

9. A method of making an optically transmissive structure comprising the steps of:
stereolithographing, molding, or otherwise forming an optically transmissive structure having a first surface, a second surface, and a third surface;
the first surface being configured and disposed to transmit light emitted from a light source and into the optically transmissive structure;
the second surface being configured and disposed to provide an angular light reflective interface at or proximate the second surface and a fluid being sensed; and
the third surface being configured and disposed to transmit light reflected from the angular light reflective interface and to an optical sensor;
directly incorporating, bonding, or adhering with an adhesive, the optical sensor within or on the third surface, of the optically transmissive structure;
wherein the incorporating, bonding, or adhering of the optical sensor minimizes a scattering of light from the light source and to the optical sensor.

10. The method of making an optically transmissive structure of claim 9 further comprising directly incorporating, bonding, or adhering a window with or to the second surface, the window is configured and disposed to provide the angular light reflective interface proximate the second surface and the fluid being sensed.

11. The method of making an optically transmissive structure of claim 10, wherein the incorporating, bonding, or adhering comprises adhering at least one the window and the optical sensor to the optically transmissive structure with an adhesive.

12. The method of making an optically transmissive structure of claim 11, wherein the adhesive is configured to provide at least a 90% desired light transmission.

13. The method of making an optically transmissive structure of claim 12, wherein the incorporating, bonding, or adhering comprises incorporating, bonding, or adhering at least one of the light source, the window, and the optical sensor to the optically transmissive structure.

14. The method of making an optically transmissive structure of claim 13, wherein the optically transmissive structure comprises a polymeric material and the incorporating, bonding, or adhering comprises placing the light source, the window, or the optical sensor onto or into a flowable polymeric material and solidifying the flowable polymeric material.

15. A method of making an optically transmissive structure comprising the steps of:
stereolithographing, molding, or otherwise forming a polymeric optically transmissive structure having a first surface, a second surface, and a third surface;
wherein the first surface is configured and disposed to transmit light emitted from a light source and into the optically transmissive structure;
wherein the second surface is configured and disposed to provide an angular light reflective interface at, or proximate, the second surface and a fluid being sensed; and
wherein the third surface is configured and disposed to transmit light reflected from the angular light reflective interface and to an optical sensor;
the three dimensionally forming comprises three dimensionally forming at least one void, opening, or slot in the optically transmissive structure;
filling the at least one void, opening, or slot with a light blocking material; and
wherein the at least one filled void, opening, or slot is configured and disposed to block a portion of the light being reflected or transmitted toward the optical sensor.

16. The method of making an optically transmissive structure of claim 15, wherein the void, opening, or slot is configured and disposed to block a portion of light above a critical angle at the angular light reflective interface.

17. The method of making an optically transmissive structure of claim 15, wherein the void, opening, or slot is configured and disposed to block a portion of light below a critical angle at the angular light reflective interface.

18. The method of making an optically transmissive structure of claim 15, wherein the void, opening, or slot is configured and disposed to block a portion of light between the light source and the sensor.

19. The method of making an optically transmissive structure of claim 15, wherein the void, opening, or slot is configured and disposed to block a portion of light between the light source and the angular light reflective interface or between the angular light reflective interface and the optical sensor.

20. The method of making an optically transmissive structure of claim 15 comprising forming a first and a second void, opening, or slot in the optically transmissive structure, the first void opening, or slot is configured and disposed to block a portion of light between the light source and the angular light reflective interface and the second void, opening, or slot is configured and disposed to block a portion of light between the angular light reflective interface and the optical sensor.
